(19) United States
(12) Patent Application Publication
(10) Pub. No.: US 2016/0069791 A1
(43) Pub. Date: Mar. 10, 2016

(54) GREEN SPEED METER AND GREEN SPEED METER CONTAINER

(71) Applicant: Robert Deloss Lamkin, Clarendon Hills, IL (US)

(72) Inventor: Robert Deloss Lamkin, Clarendon Hills, IL (US)

(21) Appl. No.: 14/846,942

(22) Filed: Sep. 7, 2015

Related U.S. Application Data
(60) Provisional application No. 62/071,751, filed on Sep. 7, 2014.

(51) Int. Cl. G01N 19/02; A63B 57/00; A63B 71/06

(52) U.S. Cl. CPC G01N 19/02; A63B 71/06; A63B 57/00

(57) ABSTRACT

The present invention discloses an apparatus for measuring golf putting green speed. The apparatus comprises a body and a head. The body includes a U-shaped channel having rounded sections on sides thereof. Further, the body includes an insert fitting down inside the U-shaped channel and having a hole. The rounded sections and the hole configured for holding a golf ball when the body is in rest position. Further, the head includes a plug and a golf ball lifting handle at one end. The plug allows one end of the body for snugly fitting therein. The golf ball rolls down along the top rails of the U channel and onto a golf putting green when the lifting handle is elevated to a preset angle, and thereby allowing for measuring green speed based on a distance covered by the ball on the golf putting green. Further, a corresponding method and a container for carrying the apparatus are also disclosed.

### BACKGROUND OF THE INVENTION

Golf is a sport that has been played for over 100 years. In addition to driving a golf ball off a tee and hitting an approach shot a golfer is faced with putting the ball. Depending on the type of grass, weather conditions, and length of grass cut, the difficulty and speed of the greens can vary from one course to another and from one day to another. The speed of the practice putting green will be a good indication of what the speed of the 18 greens on the golf course are because they are all cut by the golf course ground crew first thing each morning.

The speed of the practice putting green is determined by the distance the golf ball travels onto a flat surface of the green after rolling down a certain length ramp like devise that is raised at one end to a certain degree. The ramp like device is known as a stimpmeter and the speed or “stimp” reading of the greens is determined by measuring the distance from the end of the device to where the ball stops and ends up with a tape measure in feet and inches. The longer the distance is and the faster the green speed is, the more difficult it will be to putt the ball into the hole. The fewer the number of putts means a lower golf score at the end of the round which is the goal of being a good golfer. Being able to determine the speed of the practice putting green before playing a round of golf is important to the golfer so they can judge how hard or how soft they will need to putt the golf ball. Aiming the ball is also important in being a good putter.

The stimpmeter was originally developed by Edward Stimpson in 1937. He determined that there needed to be a uniform way to measure the speed of the greens from one golf course to another so the golfers could know in advance how fast or slow they were before playing a round of golf in a tournament so they could make adjustments. The original ramp like device Edward Stimpson came up with was a piece of wood that had a V shaped rolling channel that was 36 inches long and had an oval shaped hole which was notched out at about 30 inches to hold a golf ball.

When this device was raised to 22 degrees the ball would release from the oval hole and begin to roll down the ramp and onto the green. Edward would then measure the distance from the end of the ramp to where the ball ended up. This distance was known as the “stimp” or speed of the green. This device was manufactured and sold to the golf course superintendents throughout the United States and Europe. The speed of the green continues to be known as the “stimp” in honor of Edward Stimpson

The official Stimpmeter's current design is approved by the United States Professional Golfers Association and is used before every Pro Golfer Association tournament event. The material used to make the official Stimpmeter has evolved from one piece of wood with an oval shaped notch in it, to one piece of an aluminum with a V shaped rolling channel and two oval shaped notches in it. The one piece design is manufactured under strict tolerances and a digital identifying number is stamped in each one and is only sold to golf course superintendents.

### PRIOR INVENTIONS

U.S. Pat. No. 6,547,680 B1 to Marchese in FIG. 1C shows a one piece green speed measuring devise which has a V shaped rolling channel.

U.S. Pat. No. 7,225,663 B2 by Pelz shows a multi-piece green speed measuring devise which has three grooved rolling ramps and a trigger holding plate to release the golf balls and sits on the ground and is not raised by the operator or golfer.

U.S. Pat. No. 6,749,527 B2 by Hughes shows a foldable green speed measuring devise and sits on the ground and is not raised by the operator.

### BRIEF SUMMARY OF THE INVENTION

A green speed meter is a ramp like device that is used to assist golfers in determining the speed of the golf putting greens. The speed is the distance a test golf ball travels from the end of the device to where it comes to rest on the putting green. A green speed meter includes refinements in the design and use from prior arts. A green speed meter includes a body, and a head. The two piece body includes a rolling channel that is made up of aluminum U channel with two sides and a base and a plastic insert that fits inside and runs the length of the U channel. An opening in the two sides of the U channel and a circular hole in the insert serve to support a test golf ball in its horizontal or resting position. The top of the two sides of the U channel serve as rails for the test golf ball to roll on after the device is lifted to 22 degrees. The head includes a plastic rod which serves to provide a golf ball lifting handle at one end, a means of securing the body or rolling channel at the other end, and a means of securing or plugging the body and head in a green speed meter container A green speed meter container will securely hold the green speed meter, which can then be carried to the golf course or inserted into the golfers golf bag for added protection. A green speed meter container also has marking on it that will assist a golfer in measuring the distance a testing golf ball rolls onto a putting green.

It is the object of this present invention to provide a green speed measuring device.

It is the object of this present invention to provide a two piece rolling channel, rather than a one piece, and made of extruded aluminum U shaped channel, rather than a V shaped channel, and a plastic insert that runs the length of the channel.

It is the object of this present invention to provide a means of supporting the test golf ball in three places. The tree places are the two sides of the U channel and a circular holding hole in the U channel insert while the device is in its horizontal or resting position.

It is the object of this invention to provide a circular shaped holding hole for the test golf ball, rather than an oval shaped notched hole, and with specific measurements for the diameter and depth of the hole.

It is the object of this present invention to provide a head plug which secures the rolling channel body at one end.

It is the object of this present invention to provide a head plug which secures the golf ball lifting handle at one end.

It is the object of this present invention to provide a head plug with a strip of felt that is affixed to it and runs around the outside of it so that when the green speed meter is inserted into the green speed meter container the felt is compressed allowing the meter to fit securely inside the container.

It is the object of this present invention to provide a green speed meter container which is a tubular shaped device for storing the green speed meter when not in use.

It is the object of this present invention to provide a green speed meter container with inch markings on it to assist the golfer in measuring the distance a test golf ball travels from the end of meter to where the test golf ball stops and comes to rest on the putting green.

It is the object of the green speed meter and green speed meter container to be easily inserted into a golfers golf bag.

It is the object of the green speed meter to be easily built and available to the general public.

The accompanying drawings, which are incorporated in and constitute a part of this specification, illustrate one or more embodiments of the green speed meter and green speed meter container and together with the description serve to explain the principles of this invention.

### BRIEF DESCRIPTION OF THE DRAWINGS

FIG. 1 is a perspective view of a green speed meter.

FIG. 2 is a side view of a green speed meter.

FIG. 3 is a top view of a green speed meter.

FIG. 4 is a top view of the head plug with the U channel body inserted.

FIG. 5 is a front view of the head plug without the U channel body inserted.

FIG. 6.1 is a front view of U channel with a test golf ball resting in the holding hole and on the sides of the U channel.

FIG. 6.2 is a front view of U channel with a test golf ball rolling down the top rails of U channel.

FIG. 7 is a side view of the present invention in a horizontal resting position on a golf putting green with a test golf ball resting on the rounded sections of the sides of the U channel body and in the holding hole in the insert.

FIG. 8 is a side view of a green speed meter after the golf ball handle end is lifted to a 22 degree angle and a test golf ball begins to roll down the top rails of the U channel.

FIG. 9 is a view of a tubular green speed meter container with inch markings.

FIG. 10 is a cut a way side view of a green speed meter inserted into a green speed meter container, and a strip of felt that is affixed to the head plug and wraps around the head plug which holds the meter firmly in place inside of the container.

FIG. 11 is a side view of a green speed meter inserted into a green speed meter container.

FIG. 12 is a green speed meter inserted into a green speed meter container inserted into a golfer's golf bag.

### DETAILED DESCRIPTION OF THE INVENTION

A green speed meter is a ramp like device used to assist golfers in determining the green speed, or the distance a golf ball rolls on a golf putting green. The device will hold a test golf ball in place in the resting or horizontal position in three places. It will hold a test golf ball in place in the circular holding hole in the insert and the two sides of the U channel. When this device is lifted at the golf ball handle end and reaches 22 degrees the test golf ball is released from the two sides of the body and from the circular holding hole in the insert of the body simultaneously and with over spin and gravity begin to roll down the top rails of the U channel body and onto the golf putting green. The distance the golf ball rolls onto the putting green can then be measured.

A green speed meter container is a tubular device that is open on one end and capped at the other end and is used to hold a green speed meter when not in use or being transported without being damaged. A green speed meter container has inch marking on the tube, that run the length of the tube, and will assist the golfer in measuring the distance a test golf ball rolls from the end of the meter to where the test golf ball stops and ends up on the putting green.

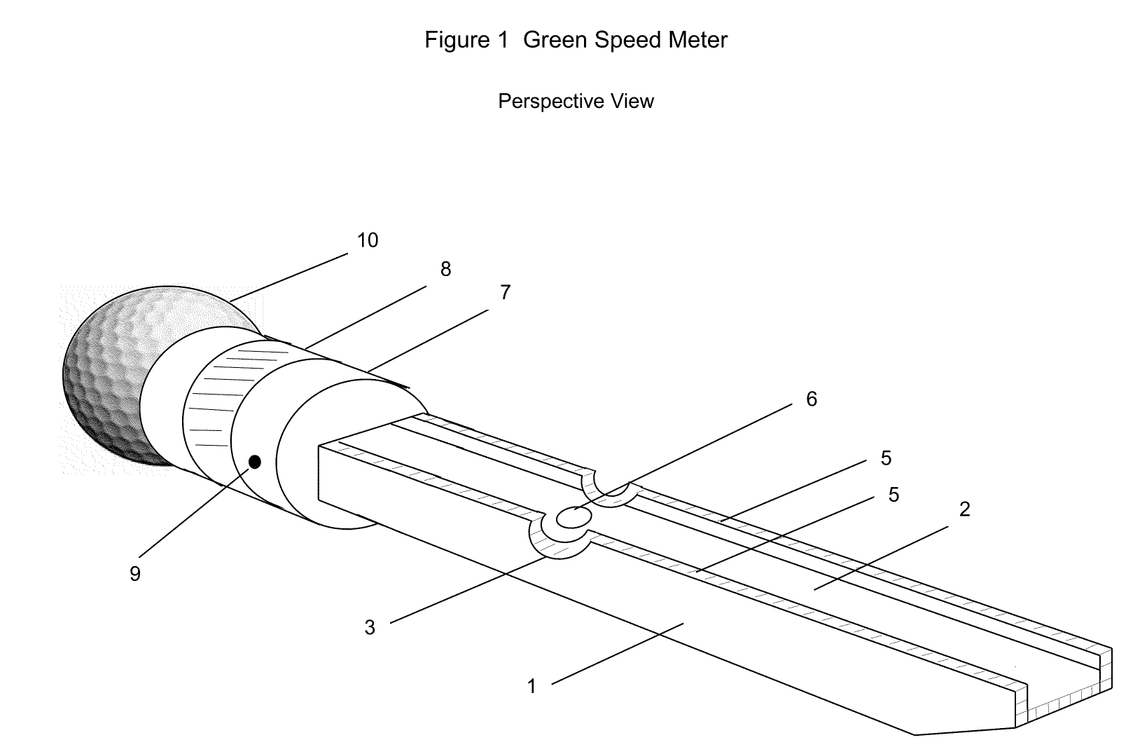

Referring to FIG. 1. The green speed meter consists of a body and a head plug. The body is made up of two pieces. It is made up of a rectangular piece of extruded aluminum U channel 1 with two sides and a base, and a rectangular plastic insert 2 which runs the length of the U channel and is affixed to and fits inside and on the base of the U channel. The head plug 7 is made up of a plastic rod material which serves to secure the body at one end and serves to hold the golf ball lifting handle 10 at the other end. The two sides of the body are 1/16 inch thick and ½ inch apart and have areas that are machined and rounded 3 that are used to hold a test golf ball in place when the device is in the horizontal or resting position. The insert 2 has a circular hole 6 which is machined to a certain depth which also serves as a holding hole for a test golf ball to rest in when the device is in the horizontal or resting position. Together the two rounded sides of the body and the circular holding hole in the insert serve to hold a test golf ball in place when the device is in the horizontal or resting position on the putting green. The top of the two sides of the U channel serve as rails 5 for a test golf ball to roll down onto when the device is lifted.

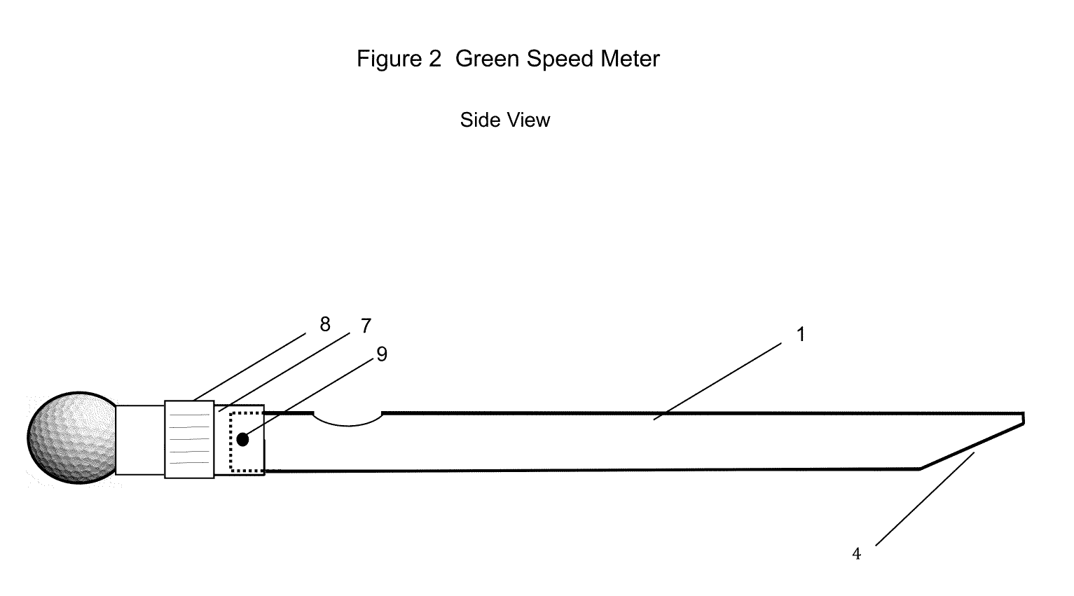

Referring to FIG. 2. The front end of the U channel 1 is beveled 4 so that when the device is lifted to 22 degrees the test golf ball will roll down the rails and onto the putting green smoothly. The back end of the U channel will fit into the head plug 7. A rectangular shaped opening is machined at one end of the plastic rod head plug to a depth to accept the rectangular shaped aluminum U channel body and hold it firmly in place. The U channel body is affixed in the head plug and a rod 9 is inserted through the side of the U channel and through the insert and through the other side of the U channel to prevent the U channel from separating from the head plug. Around the center section of the plastic head plug is a strip of felt 8. The strip of felt 8 is affixed onto and runs around the head plug. This strip of felt will allow for enough compression for when the plastic rod head plug and body of the green speed meter is inserted into a green speed meter container, it will fit securely inside for storage or transportation without falling out and being damaged.

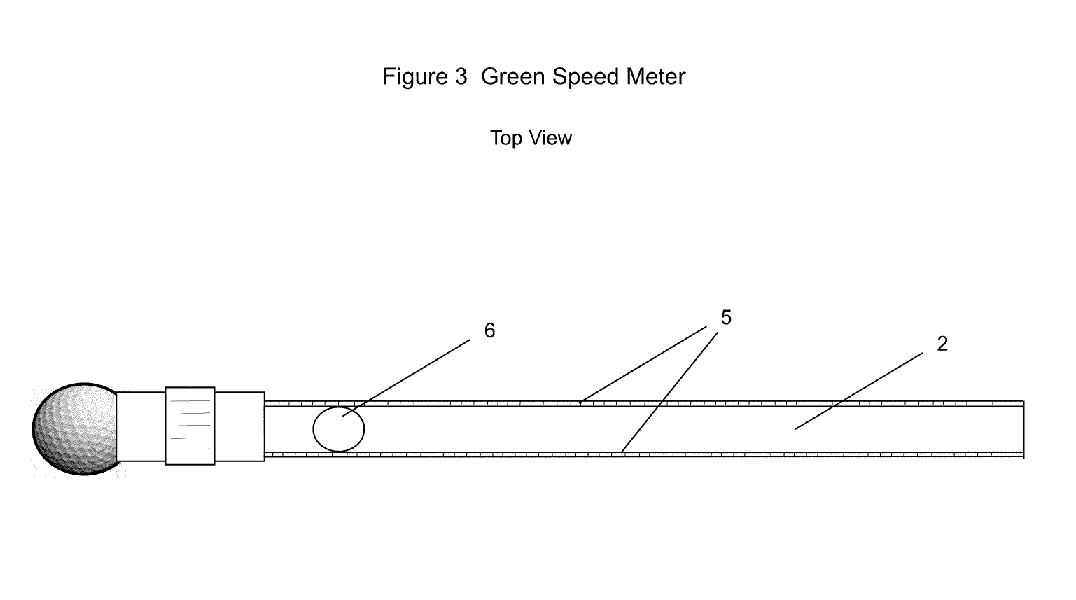

Referring to FIG. 3. The top view shows the placement of the circular holding hole 6 at thirty inches from the end of the insert 2. The circular hole is 15.75 mm in diameter and 1.95 mm in depth. The combination of this diameter and depth measurements, along with the two rounded sections of the sides of the U channel allow the test golf ball to be released when the end of the device is lifted to 22 degrees.

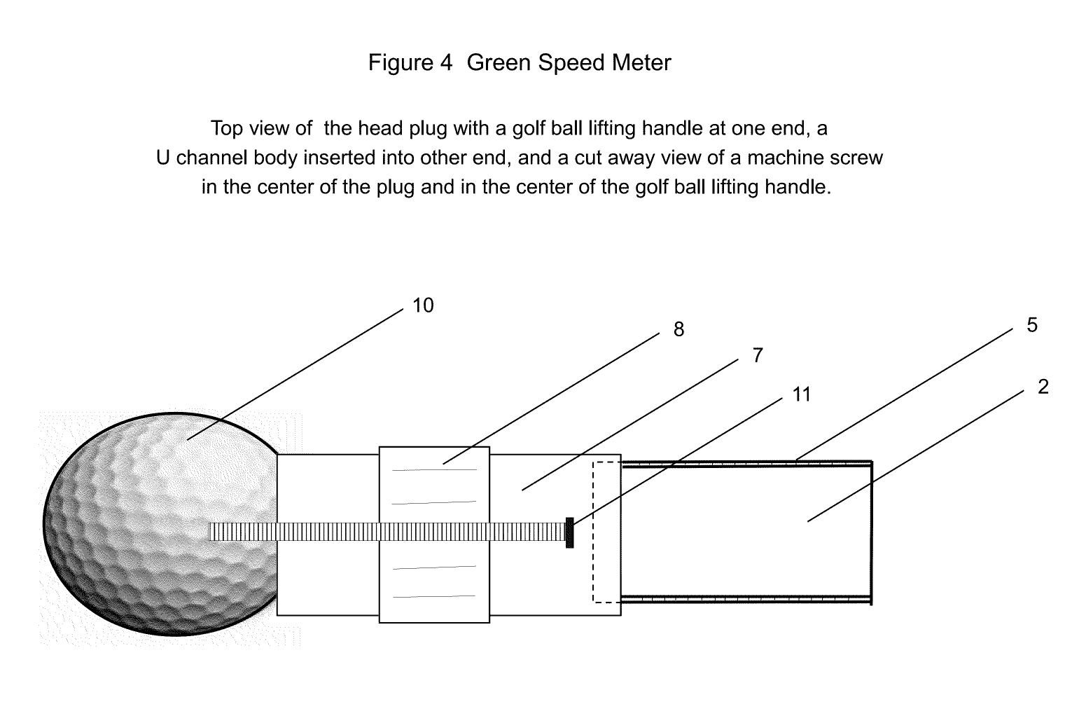

Referring to FIG. 4. The plastic rod head plug has a hole drilled in the center, which runs the length of the plug, which holds a machine screw 11. The golf ball lifting handle will have a hole drilled into it and then tapped to accept the machine screw. The machine screw when tightened will hold the golf ball lifting handle and the plastic head plug firmly together.

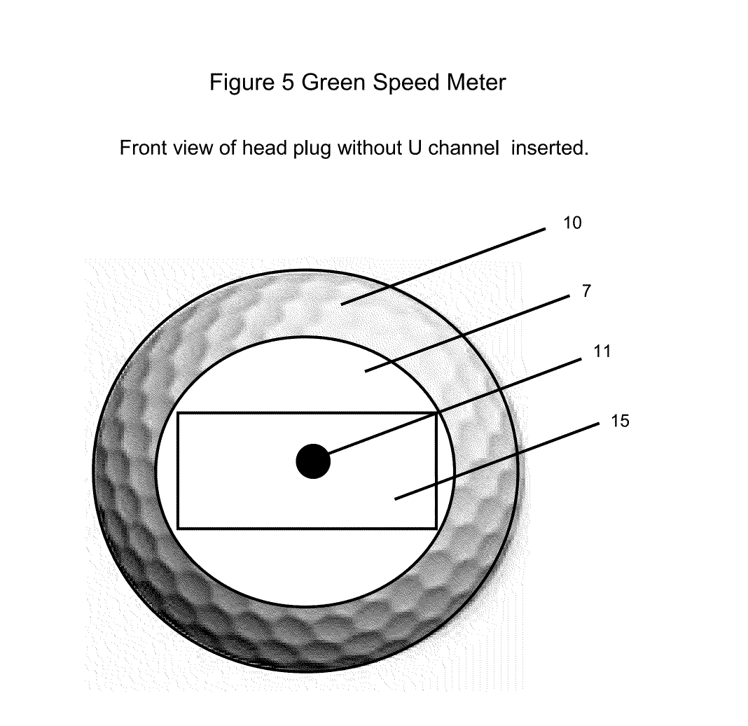

Referring to FIG. 5. A rectangular shaped opening 15 is machined in the head plug which will allow the non beveled end of the body to be inserted.

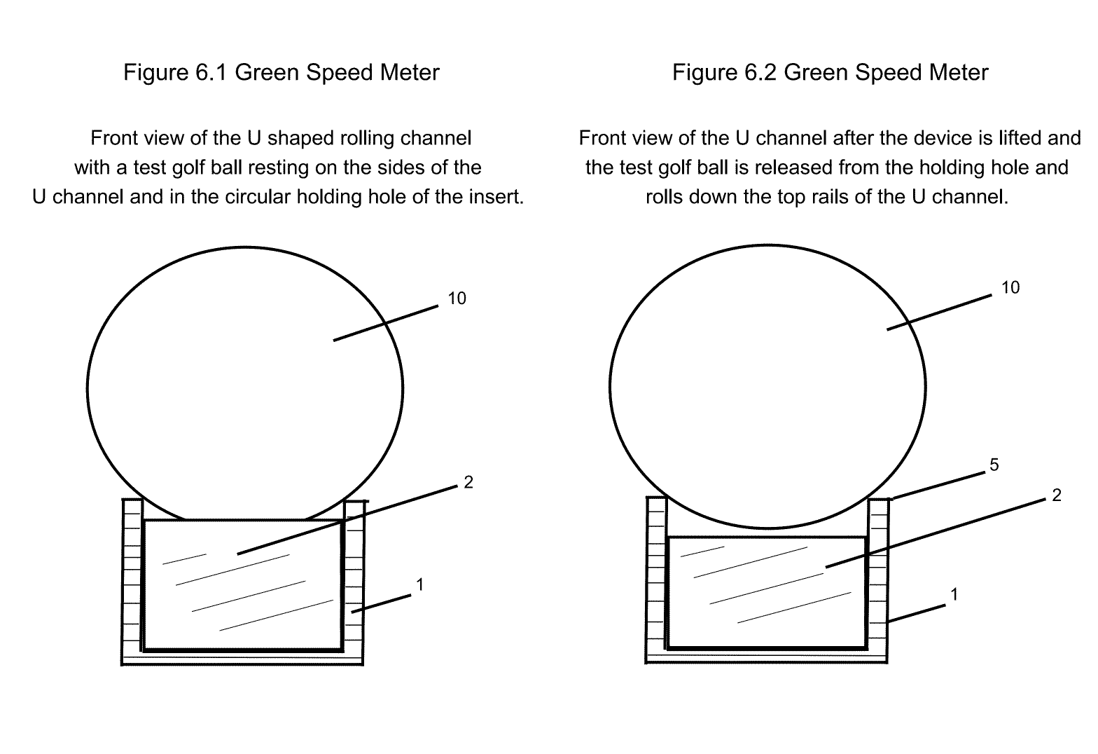

Referring to FIG. 6.1. Illustrates the front view of the U channel 1 with a test golf ball in the resting position in the holding hole and in a resting position on the two sides of the U channel body.

Referring to FIG. 6.2. The front view of the U channel 1 after the device is lifted to 22 degrees and the test golf ball 10 begins to roll down the top rails 5 of the U channel.

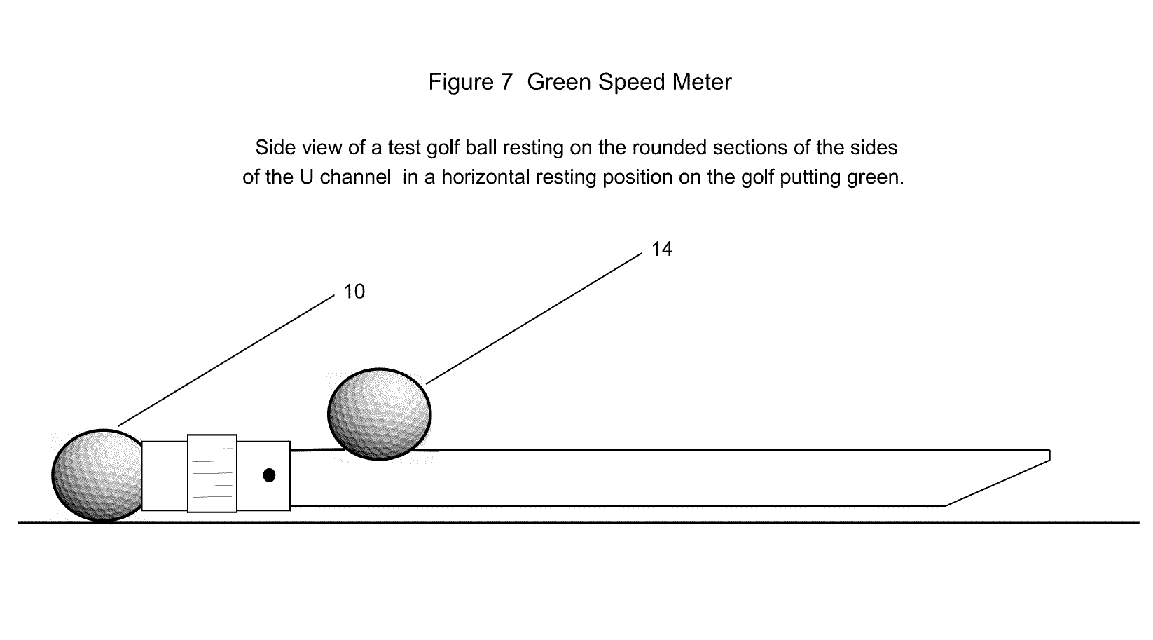

Referring to FIG. 7. The green speed meter is in it's horizontal or resting position on the golf putting green. In this position a golfer will place a test golf ball 10 in the holding hole and on the rounded section of the sides of the U channel.

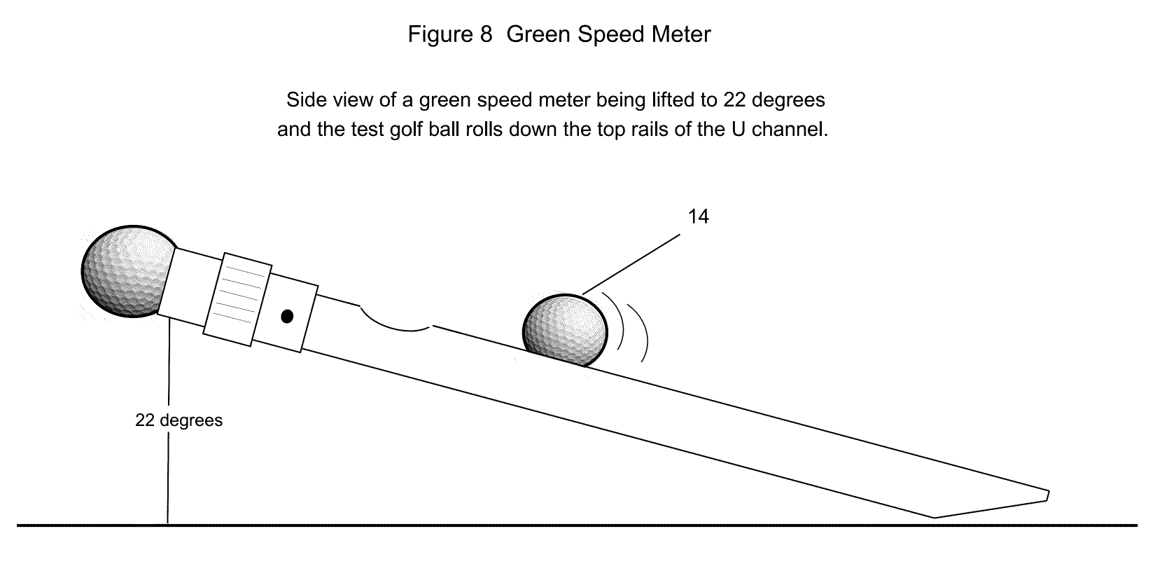

Referring to FIG. 8. The golfer will then slowly lift the golf ball handle end until it reaches a 22 degree angle. At this point the test golf ball will release from its resting position and with over spin and gravity travel down the top rails of the sides of the aluminum U channel body and onto the golf putting green. The golfer will then measure the distance from the end of the beveled edge of the green speed meter to where the golf ball stops and ends up on the golf putting green. This can be done with a green speed meter container. The green speed meter container has inch marking on it that run the length of the tube and acts as a measuring tape. The golfer will do this with two more balls and then average the distance of the three measurements. This distance is known as the speed of the golf putting green. This information can then be used to gauge how fast or how slow the rest of the golf putting greens are when a golfer is putting. The faster the greens are or higher the green speed is, the more difficult it will be for a golfer to putt the golf ball into the hole. The more strokes it takes for the golfer to sink the golf ball into the hole the higher their golf score will be.

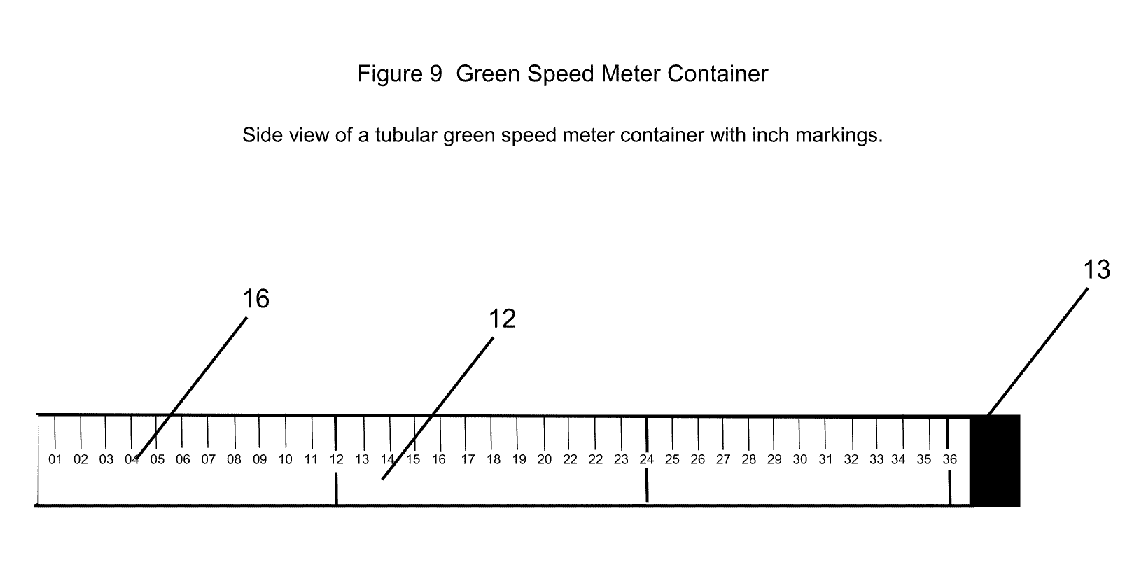

Referring to FIG. 9. The green speed meter container is a plastic tubular device that is open on the top end and capped on the bottom end 13 and has inch markings on it 16 that run the length of the tube. With the inch markings the container can then be used like a tape measure to measure the distance from the end of the green speed meter to where the test golf ball stops and ends up on the putting green. The top end is open to allow for the green speed meter with the handle, the plug, and channel to be inserted.

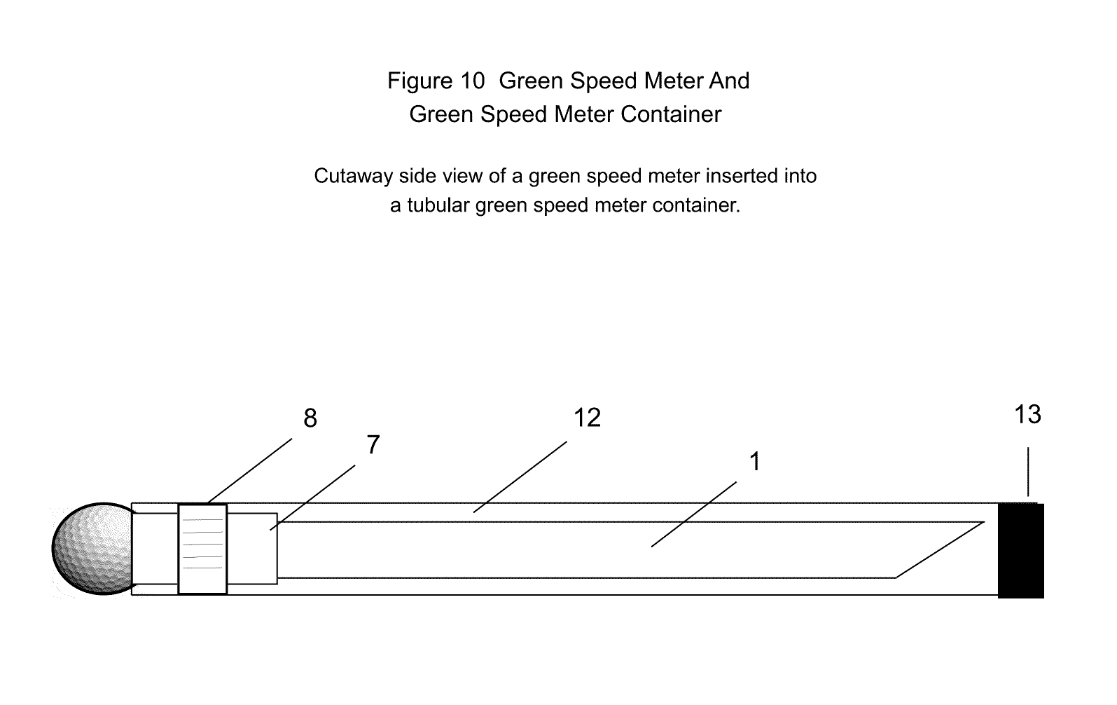

Referring to FIG. 10. This is a cutaway view of a green speed meter inserted into a green speed meter container. Affixed around the center section of the head plug 7 is a strip of felt 8. The thickness and nature of any piece of felt will allow for compression when something is pressed against it and then it will decompress back. When the plastic rod head plug is inserted into a green speed meter container the 1/16 inch thick strip of felt is compressed just enough to allow the plug to fit securely inside the container for storage and transportation without falling out and being damaged, and allow for easy removal when the device needs to be used.

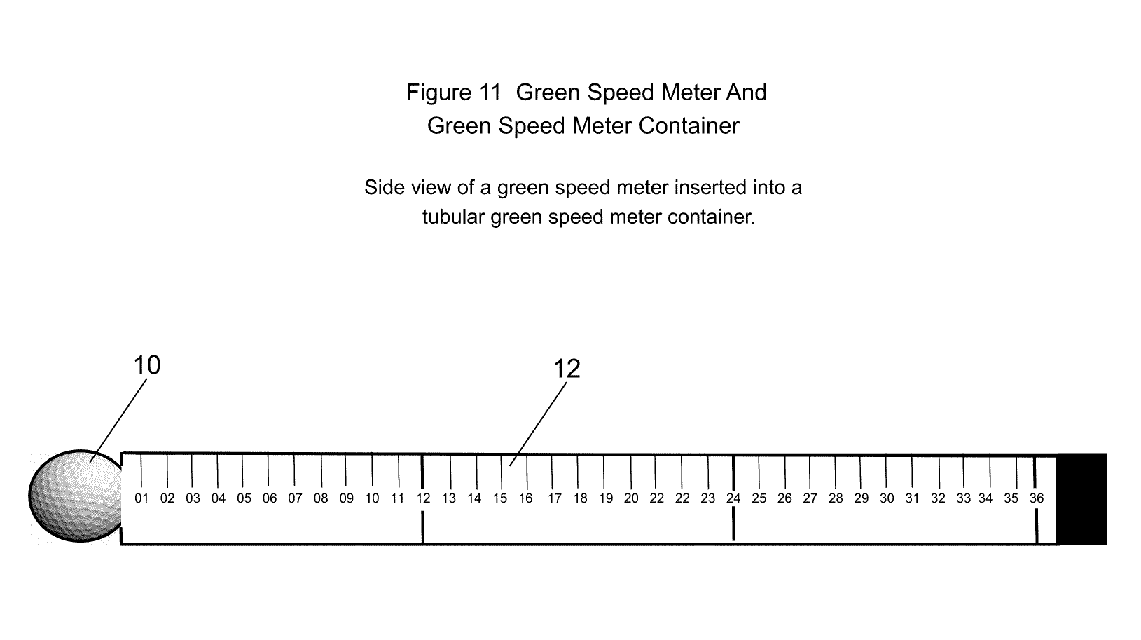

Referring to FIG. 11 This is an outside view of a green speed meter fully inserted into a green speed meter container 12 The golf ball lifting handle 10 is the only part of the green speed meter showing.

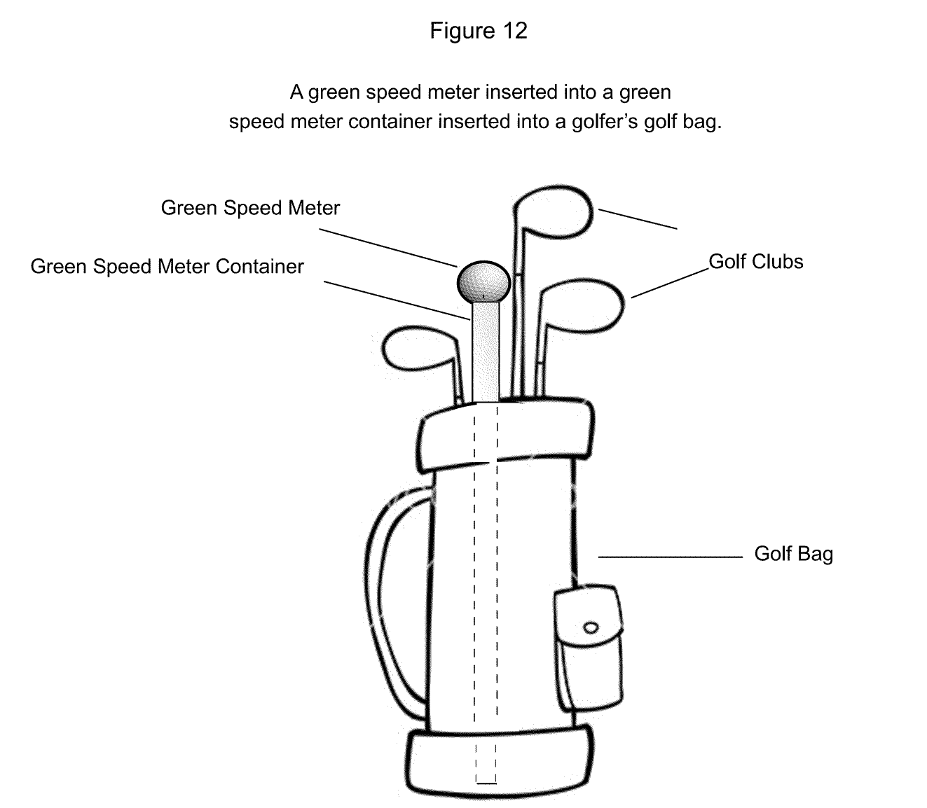

Referring to FIG. 12. The green speed meter inserted into a green speed meter container inserted into a golfer's golf bag.

Parts and Item Table

| | |
|---|---|
| 1 | Aluminum U channel body |
| 2 | Rectangular plastic insert |
| 3 | Rounded sections of the sides of the aluminum U channel body |
| 4 | Beveled edge on the bottom of the aluminum U channel body |
| 5 | Top edge or rail of the aluminum U channel body |
| 6 | Circular holding hole for the testing golf ball |
| 7 | Plastic rod head plug |
| 8 | Strip of felt affixed to the outside of the plastic head plug |
| 9 | Rod to hold U channel body in place in head plug |
| 10 | Golf ball lifting handle |
| 11 | Machine screw |
| 12 | Plastic tubing |
| 13 | Bottom end cap |
| 14 | Test golf ball |
| 15 | Rectangular opening in the head plug |
| 16 | Inch marking on the green speed meter container |

What is claimed is:

1. An apparatus for measuring green speed, the apparatus comprising:
a body, the body comprising:
a rectangular piece with a U-shaped channel having rounded sections on sides thereof; and
an insert fitting down inside the U-shaped channel and having a hole, the rounded sections and the hole, in combination, configured for holding a golf ball when the body is in rest position; and
a head comprising:
a plug on one end, and a golf ball lifting handle on other end thereof, the plug allows one end of the body for snugly fitting therein, and
wherein the ball rolls down along the top rails of the U channel and onto a golf putting green when the golf ball lifting handle is elevated to a preset angle, thereby allowing for measuring green speed based on a distance covered by the ball on the golf putting green.

2. The apparatus of claim 1, wherein the distance covered by the ball is measured from a point of landing of the ball onto the golf putting green to a position of stopping the ball on the golf putting green.

3. The apparatus of claim 1, wherein the body comprises two sides, a base, and two ends.

4. The apparatus of claim 3, wherein the two ends comprise a bottom end and a top end, the bottom end being beveled at an angle to enable the ball to roll down along the insert and onto the golf putting green when the golf ball lifting handle is elevated.

5. The apparatus of claim 1, wherein the U-shaped channel is made from aluminum.

6. The apparatus of claim 1, wherein the insert is made up of plastic and is affixed to and runs along the length of the U-shaped channel.

7. The apparatus of claim 1, wherein the golf ball lifting handle is elevated to lift the body from the rest position to the pre-set angle.

8. The apparatus of claim 1, wherein the head comprises a strip felt which is affixed around the plug for firmly placing the apparatus into a container.

9. A method for measuring green speed, the method comprising:
elevating a golf ball lifting handle of an apparatus to an angle, the apparatus comprising: a body, the body comprising:
a rectangular piece having a U-shaped channel having rounded sections; and
an insert fitting down inside the U-shaped channel and having a hole,
the rounded sections and the hole, in combination, configured for holding a golf ball when the body is in rest position; and
a head comprising a plug on one end a golf ball lifting handle on other end thereof,
the plug allows one end of the body for snugly fitting therein, and
wherein the ball rolls down along the top rails of the U channel and the top of the insert and onto a golf putting green when the lifting handle is elevated to a preset angle; and
measuring a distance covered by the ball from a point of landing of the ball onto the golf putting green to a position of stopping the ball on the golf putting green; and
determining the green speed based on the measured distance.

10. The method of claim 9, wherein the body comprises a bottom end and a top end, the bottom end being beveled at an angle to enable the ball to roll down along the insert and onto the golf putting green when the golf ball lifting handle is elevated.

11. The method of claim 9, wherein the U-shaped channel is made from aluminum.

12. The method of claim 9, wherein the insert is made up of plastic and is affixed to and runs along the length of the U-shaped channel.

13. The method of claim 9, wherein the golf ball lifting handle is elevated to lift the body from the rest position to the pre-set angle.

14. The method of claim 9, wherein the distance is measured for at least three balls.

15. The method of claim 9, wherein the preset angle is 22 degrees.

16. A container for carrying an apparatus for measuring green speed, the container comprising:
a tubular structure having an opening at a top end and capping on a bottom end thereof, inch markings on the outside to allow for measurements, and the top end allows for inserting the apparatus in the tubular structure,
wherein the apparatus comprising:
a body for holding a golf ball, when the body is in resting position;
a head comprising a plug at one end and a golf ball lifting handle at other end thereof, the plug allows one end of the body for snugly fitting therein, wherein the head comprises a strip of felt adhered around the plug for firmly placing the apparatus into the tubular structure, when the apparatus is inserted in the tubular structure.

17. The container of claim 16, wherein the ball rolls down along the top rails of the U channel and the top of the insert and onto a golf putting green when the lifting handle is elevated to a preset angle.

18. The container of claim 16, wherein the lifting handle comprises a golf ball.

19. The container of claim 16, wherein the golf ball lifting handle remains outside the tubular structure when the apparatus is firmly placed inside the tubular structure.

20. The container of claim 16, wherein the thickness of the felt is compressed to place the apparatus firmly inside the tubular structure when the apparatus is inserted in the tubular structure.
